(19) United States
(12) Patent Application Publication
(10) Pub. No.: US 2017/0169804 A1
(43) Pub. Date: Jun. 15, 2017

(54) DRUMSTICK GRIP AND PERFORMANCE ENHANCEMENT

(71) Applicant: David Glen Peridore, Paris, TN (US)

(72) Inventor: David Glen Peridore, Paris, TN (US)

(21) Appl. No.: 15/376,646

(22) Filed: Dec. 12, 2016

Related U.S. Application Data
(60) Provisional application No. 62/386,727, filed on Dec. 10, 2015.

(51) Int. Cl. G10D 13/00

(52) U.S. Cl. CPC G10D 13/003

(57) ABSTRACT

The specification discloses a novel drumstick configuration with an enhanced grip and performance characteristics. Included in the drumstick are a plurality of preferably continuous circumferential longitudinally spaced-apart grooves disposed in an outer surface of an elongate body portion. The grooves each contain a grip-enhancing material which has an upper surface disposed slightly above the outer surface of the body portion to enhance the grip and general performance characteristics of the drumstick.

### CROSS-REFERENCE(S) TO RELATED APPLICATION(S)

This nonprovisional application claims priority to U.S. provisional patent application 62/386,727 filed Dec. 10, 2015.

### FIELD

Drumsticks are provided in a variety of forms; however, most drumsticks have an elongated shaft that expands to a proximal or gripping end, and an opposed tapered tip end having an enlarged tip formation, often bullet-shaped, for tapping the surface of a drum, symbol, bell, or other sound-producing device. Most conventional drumsticks are unitary, made of wood or plastic, and have a smooth outer surface.

Due to wear, perspiration, and other factors slippage of the hand or fingers on the handle end of drumsticks can be a chronic problem.

The above and other drawbacks of conventional drumsticks have given rise to various attempts to improve grip and performance characteristics, but no universally adopted design has emerged that addresses these and other problems.

### SUMMARY

With regard to the above and other needs, the present invention provides a drumstick with novel grip and performance characteristics. In one embodiment, the drumstick comprises an elongated body with an outer surface and a proximal handle end for being gripped by a user and a distal end shaped for tapping a sound-producing surface. The body includes a plurality of longitudally space-apart grooves on its outer surface disposed generally transfer to the length axis of the body and position adjunct the proximal handle end. The grooves contain a generally soft, elastic, relatively tacky material having an upper surface disposed to extend to a grip-contacting height above the outer surface of the body so as to enable grip-enhancing contact with the hand of the user.

As used herein, the term “relatively tacky” means the material exhibits a friction coefficient greater than that of the adjacent surface of the body of the drumstick. In a preferred embodiment, the grooves are substantially continuous, encircling the body of the drumstick, and the material in the grooves is provided by rubber o-rings having resilient elasticity to enable them to be stretched into position within the grooves. And the cross-section diameter of the o-rings are slightly greater than the depth of the grooves so that the surfaces of the o-rings project slightly above the surface of the drumstick body.

### BRIEF DESCRIPTION OF DRAWING

Other objects and advantages of the invention will now be described in further detail in the following description of one or more preferred embodiments, with reference being made to the accompanying of drawings, in with:

FIG. 1: is an elevational view of a one embodiment of a drumstick according to the invention;

FIG. 2: is an enlarged partial side elevational view of the drumstick of FIG. 1, together with plan views of grip-enhancing o-rings according to an embodiment of the invention; and

FIG. 3: is an elevational view of an embodiment of the invention in which the o-rings of FIG. 2 are position in a plurality of grooves formed in the outer surface of the drumstick.

### DESCRIPTION OF PREFERRED EMBODIMENTS AND FEATURES OF THE INVENTION

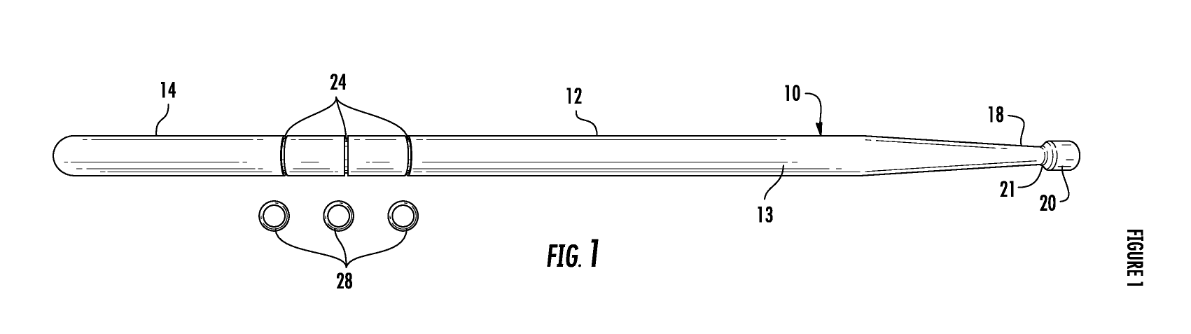

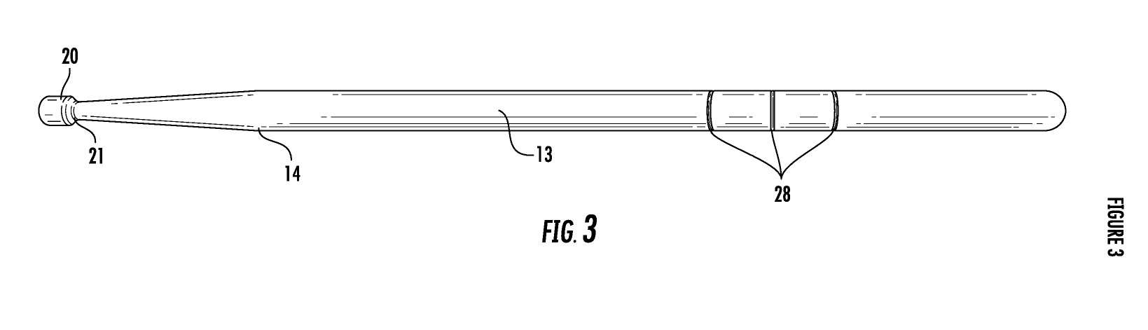

Referring now to the drawings in like reference characters designate like or similar parts throughout the simple views, FIGS. 1 through 3 illustrate various aspects one preferred embodiment of a drumstick 10 according to the present invention. In the illustrated embodiment, the drumstick 10 includes an elongate body 12 having an outer surface 13 and a proximal handle end 14 for being gripped by a user. A distal end 18 tappers to a tip 20 which enlarges from a neck 21 to provide a generally bullet-shaped formation on the end of the drumstick 10 for tapping a sound-producing surface in the well-known manner. A plurality of grooves 24 are formed in longitudally spaced-apart positions in the outer surface 13 of the drumstick 10 adjacent the proximal handle end 14. The grooves 24 are preferably shaped to accept a plurality of individual o-rings 28, preferably formed of a rubbery, elastomeric material.

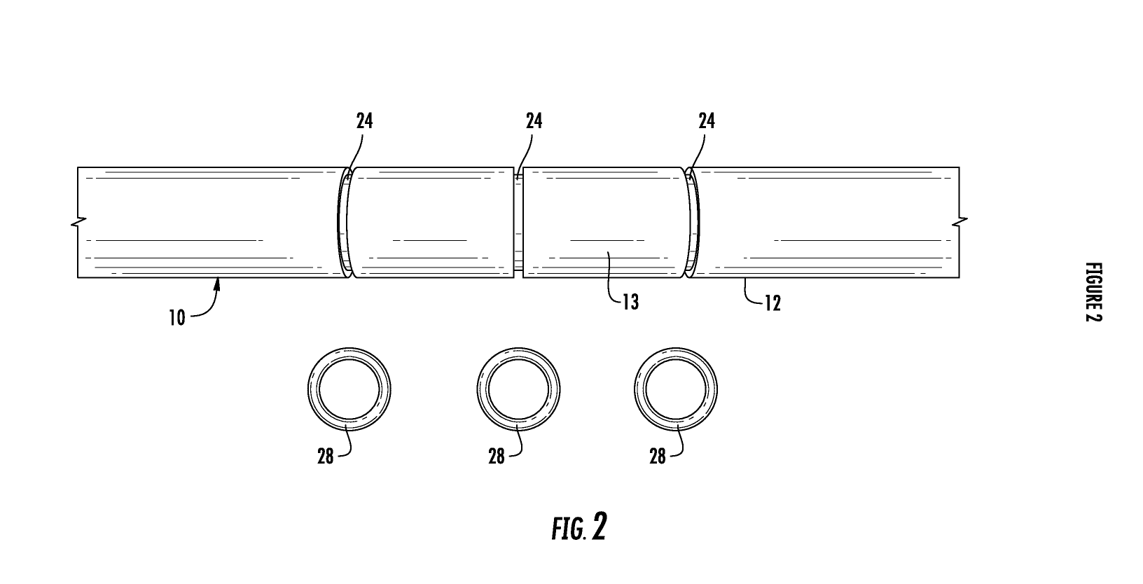

As best seen in FIG. 2, the o-rings 28 are preferably donut-shaped, and therefore consist of a continuous tubular length of rubbery, elastomeric material. Most preferably, the o-rings have a cross-sectional diameter of about ten to twenty percent greater than the depth of the grooves 24 so that when, placed in the grooves 24, the outer surface of the o-rings projects slightly above the outer surface 13 of the proximal handle end 14 of the drumstick 10; and the material is an ethylene propylene co-polymer material.

In one preferred embodiment, the drumstick has an overall length of about 16 inches and the proximal handle end 14 has a diameter of about 0.6 inches. In the illustrated embodiment, three grooves 24 are provided. Preferably, the grooves 24 are uniformly spaced apart by about 1 inch; that is, 1 inch between the first, second, and third groove 24. And the groove 24 closest to the proximal hand end 14 is preferably spaced about 2.5 to 2.7 inches, most preferably about 2.6 inches. The remaining dimensions of the drumstick may be conventional, including those of the distal end 18 and associated tip 20.

The grooves 24 may have a depth of about 0.07 inches, but this may vary depending on the dimensions of the o-rings 28, which are preferably uniform within the set. In this regard, while three grooves 24 carry three o-rings 28, it is believed that four or more grooves 24, and in some cases less than three grooves 24, and a corresponding number of o-rings 28 may be used in the practice of the invention.

The overall shape of the drumstick 10 may therefore be generally the same of that of conventional drumsticks, as well as its overall dimensions and materials of construction. Accordingly, drumsticks 10 according to the invention may be formed of wood, plastic, a suitable metal such as aluminum alloy of suitable properties, or any other material from which drumsticks may or will, in the future, be made.

Manufacture of drumsticks 10 according to the invention is relatively simple and of minimal cost, and the grooves 24 may be of any shape appropriate to accommodate the shape of the o-rings 28.

Furthermore, being stretchable, the o-rings 28 may be enlarged to fit over an end of the drumstick 10 and essentially rolled up the preferred cylindrical surface of the drumstick 10 to their position in grooves 24, where they will snap into place. Again, it is preferred material of o-rings 28 exhibit a higher coefficient of friction than that of the adjacent surface 13 of the drumstick 10 to provide enhanced tactility and feel to the user for improved of performance and reduced slippage. This frictional difference may be accomplished by use of a material for the o-rings 28 that exhibits a relatively tacky feel compared to that of the body 12 of the drumstick 10.

An advantage of the particular above-described embodiment is the relatively easy replacement of o-rings 28 due to wear and other needs that can arise during use.

While preferred embodiments of the invention have been described and shown in the drawings, many modifications thereof may be made by those skilled in the art without departing from the spirit of the invention, and it is intended to protect by Letters Patent all forms of the invention falling within the scope of the following claims.

What is claimed:

1. A drumstick which comprises an elongate body with an outer surface and a proximal end for being gripped by a user and distal end having a tip shaped for tapping a surface, the body having a plurality of longitudally spaced-apart grooves in its outer surface disposed generally transverse to the length axis of the body in disposed adjacent the proximal end, one or more of said grooves containing a elastomeric material having an upper surface extending to a grip-contacting height above the outer surface of the body so as to cause grip-enhancing contact with the hand or fingers of a user.

2. A drumstick according to claim 1, wherein said grooves are continuous.

3. A drumstick according to claim 1, wherein said grooves are substantially continuous, encircling said body, and arranged in generally parallel spaced-apart planes, each oriented generally transverse to the length axis of the drumstick.

4. A drumstick according to claim 1, wherein said elastomeric material in said grooves comprises a plurality of o-rings dimension to engagingly fit within said grooves so as to dispose their outer surfaces slightly above the outer surface of the body of the drumstick.
